(19) United States
(12) Patent Application Publication
(10) Pub. No.: US 2013/0062157 A1
(43) Pub. Date: Mar. 14, 2013

(54) Transporter of passengers system with continuous movement

(71) Applicant: Omar Perfecto Betancourt, Miami, FL (US)

(72) Inventor: Omar Perfecto Betancourt, Miami, FL (US)

(21) Appl. No.: 13/228,440

(22) Filed: Sep. 8, 2011

(51) Int. Cl. B66B 21/12; B66B 21/10

(52) U.S. Cl. 198/334; 198/321

(57) ABSTRACT

This invention is related to a Passengers' Transportation System and refers to a system of two mechanisms that allows the transportation of passengers without stopping to drop or incorporate them. They are: a Covered Linear Transporting Floor mechanism and a Uniformly Varied Movement Mechanism.

This system includes a covered linear transporting floor that moves at a constant speed which is equivalent to the average speed of vehicles in a city. The Covered Linear Transporting Floor Mechanism connects different points on a given route while the other one with the Uniformly Varied Movement Mechanism allows passengers get on and off of the Covered Linear Transporting Floor Mechanism by themselves.

The gradual change in speed is achieved by having the floor of the Uniformly Varied Movement Mechanism, made of sliding steps that slide one on top of the other, at different speed ranges, guided by a set of rails and speed variation systems that could be mechanical, electro-mechanic or electromagnetic. On both sides of uniformly varied speed mechanism, two rails are mounted handrail speed synchronized with their movement, built with a mechanism similar to yours at the appropriate scale to be supported with the hands.

This invention can work in a continuous mode as a whole during the high demanding hours, or can stop and move only some sections of seats, as a conventional suspended transportation system when the demand decreases.

This invention is applicable as an alternative or as a complement to the existing urban transportation systems; access to stadiums or airports; commercial or touristic areas, where it can help to significantly cuts the costs.

### CROSS-REFERENCE TO RELATED APPLICATIONS

This application is the continuation of a U.S. provisional application 61/403,119 filed on Sep. 11, 2010 with confirmation number 2102 dated Sep. 29, 2010

### STATEMENT REGARDING FEDERALLY SPONSORED RESEARCH OR DEVELOPMENT

N/A

### BACKGROUND OF THE INVENTION

Every known system of urban passengers' transportation must stop to drop or pick passengers up, imposing severe limitations to their efficiency. Many attempts have been made and several inventions have been patented to have them have continuous movement, with no results so far because of their complexity and high volume.

### DETAILED DESCRIPTION OF THE INVENTION

### Present Issues Resolved by This Invention

Incapacity of the current streets/highways system to handle the increase in the number of circulating vehicles.
High level of pollution.
High cost of individual transportation.
Extensive time and fuel consumption during rush hours and traffics bottlenecks.
High number of lives and resources losses in traffic accidents.
High rate of energy consumption per passenger.
Elevated stress level because of transportation issues.
Incapacity of traditional transportation systems to perform during adverse weather conditions.

### How This Invention Resolves the Presented Issues

By using a continuous principle of functioning, different to the actual non continuous principle.
Due to being a continuous system, the waiting time would be reduced to zero.
The current structure of the transportation systems can be utilized to implement this invention, reducing the investment costs.
By using electromagnetic or solar power, the level of pollution would be reduced to its minimum.
Its operation is fully automatic and centralized.
The cost of transporting a passenger would be very low when compare to the actual costs.
It would reduce the current traffic bottlenecks.
It could be used in touristic areas.
Its capacity of transport can be as high as 300,000 passengers per hour in a single route.

This invention decreases the consumption of energy, by not having losses due to acceleration or braking. Travel times could be exact, since the system would always be present and in movement.

### Components of the Invention

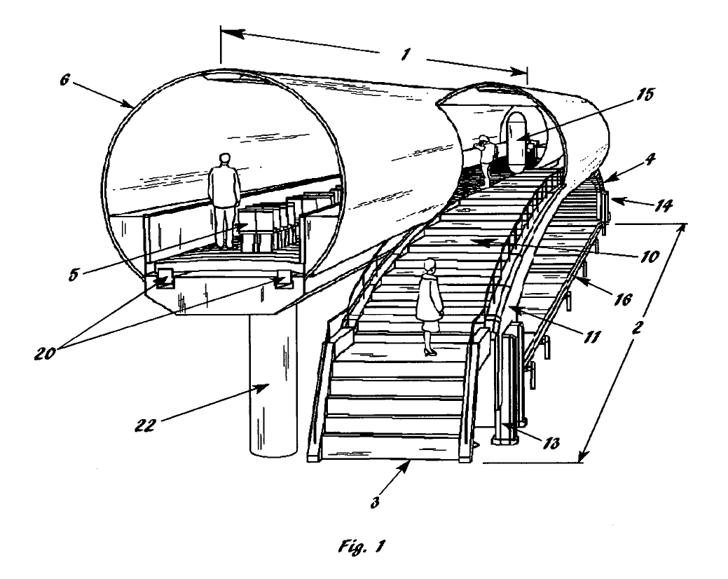

The system is made of two transporting mechanisms. One possesses a continuous uniform movement: Covered Linear Transporting Floor Mechanism (1) FIG. 1 columnar base is mounted on (22) FIG. 1 and another of uniformly varied movement: Uniformly Varied Movement Mechanism is like an escalator with overlapping sliding steps (2) FIG. 1. The Covered Linear Transporting Floor Mechanism connects different points on a given route, while the Uniformly Varied Movement Mechanism accommodates the speed of the passengers to be able to access in Entrances (3) FIG. 1 or get off in Exits (4) FIG. 1.

The Covered Linear Transporting Floor Mechanism includes a vertical cylinder inflatable rubber (15) FIG. 1, to prevent accidents.

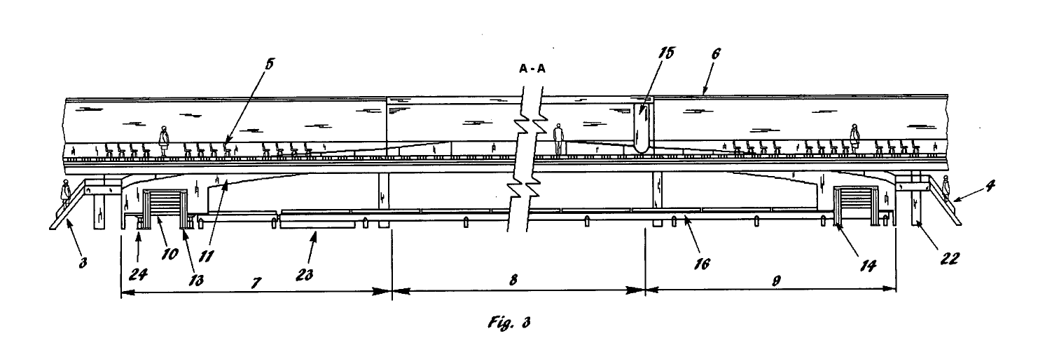

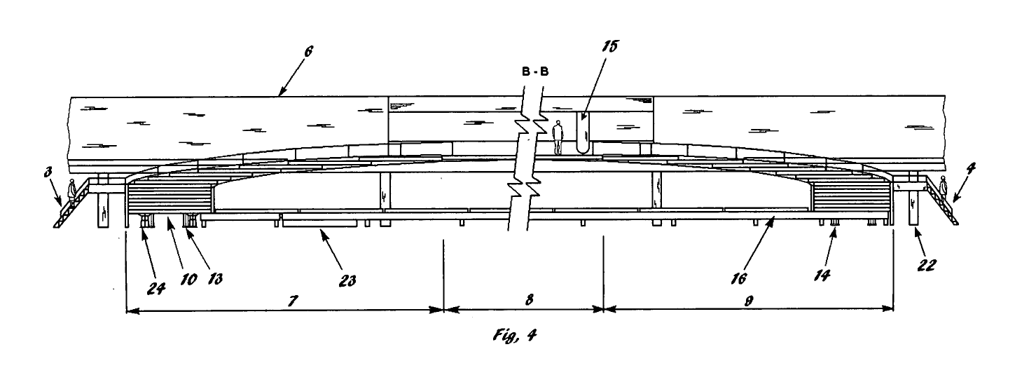

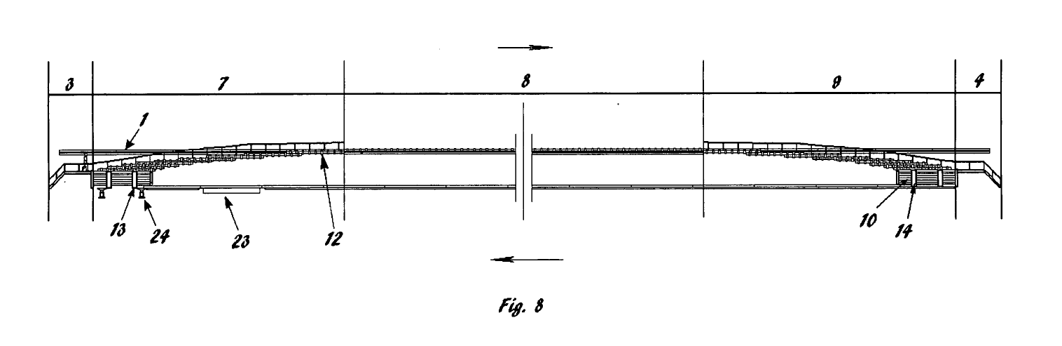

The Covered Linear Transporting Floor Mechanism is formed by a mechanism, where a surface or mobile floor with seats (5) FIG. 1, runs on the interior of a tunnel with a transparent cover (6) FIG. 1, or fixed structure. This floor could be stopped and part of its seats folded to allow the movement of selected sections only, acting like a conventional suspended system, in times of low demand. The Uniformly Varied Movement Mechanism would be built on the designated locations for access to the Covered Linear Transporting Floor Mechanism and has three different zones of speed: one for acceleration (7), one with constant speed (8) and another of deceleration (9) FIGS. 3, 4 and 8. The zone with constant speed allows the passenger to get on or off the moving Covered Linear Transporting Floor Mechanism from/to the Uniformly Varied Movement Mechanism since it is positioned in an adjacent position and will have the same speed as the Covered Linear Transporting Floor Mechanism, creating an effect of relative rest among the two transporters.

The Varied Speed Mechanism is like an escalator with overlapping sliding steps, which slide over each other, extending its free surface from the entrance to the area of uniform motion, where they are not overlapping, but in a full length one behind another and from this zone to the exit they overlap again and fall back on each other, cutting its free surface, until they reach the same length as in the entrance. As the length of the steps varies and must pass the same amount for a given point at the same time, the moving speed will be varied in the same proportion as the length of the steps.

If the length of the stairs is at the entrance and at the exit, 5 times lower than in the constant speed zone where they are in their full length, the speed rate will be 5 times higher than at the entrance and at the exit.

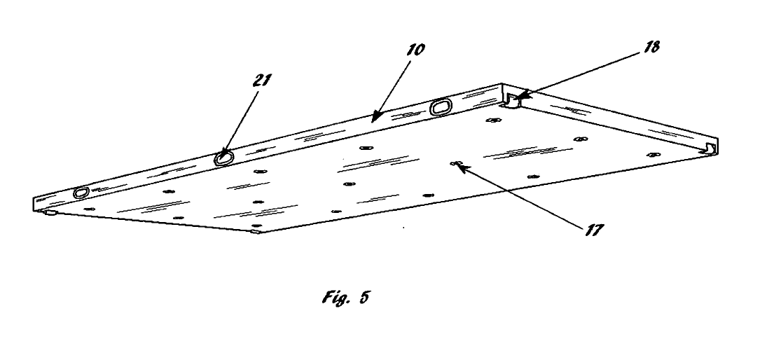

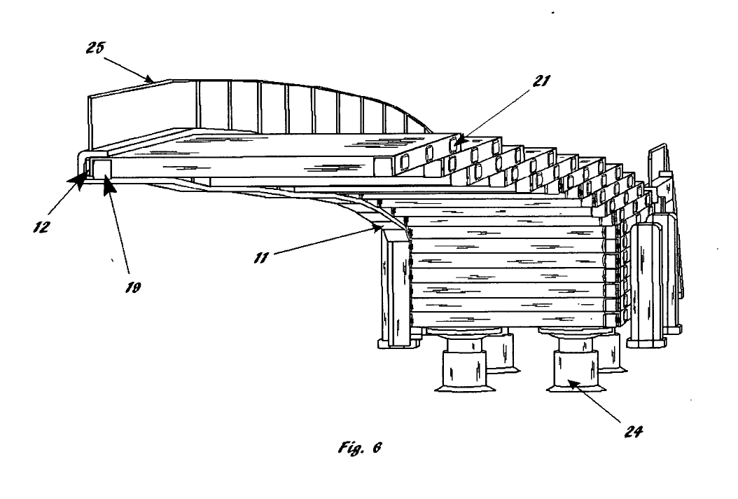

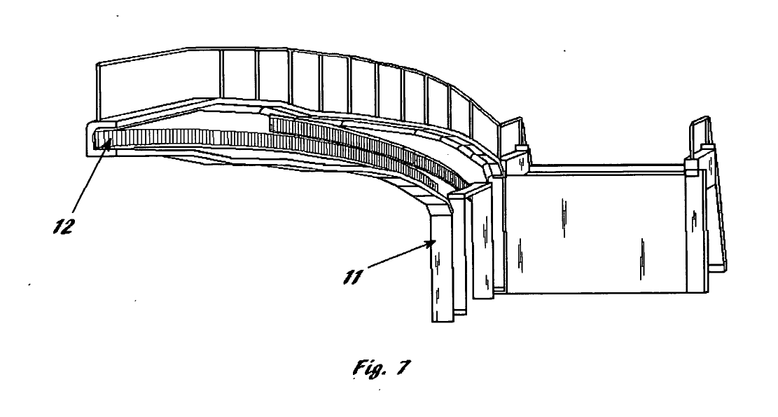

The Uniformly Varied Movement Mechanism is made of a laminar floor composed by sliding steps (10) FIG. 5, that slide one on top of the other; with such a size, that the changes in speed do not jeopardize the safety of the passengers. The movement of these sliding steps is controlled by using a set of guides (11) FIGS. 1 and 6, that make these sliding steps to follow a convenient predefined path, powered by a speed variation system, through a series of electromagnets (12) FIG. 7, that are powered according to a computer-controlled sequencer, which attract metal inserts (21) FIG. 5, that are all over the side of the sliding steps (10) FIGS. 5, 6 and 7.

The sliding steps are exchanged on the top and bottom portions of the transporter by elevation (13) and descent mechanisms (14) located at the start and end of the system. These sliding steps follow a closed trajectory (FIGS. 3 and 5), beginning on an elevation mechanism, which delivers their output to a longitudinal movement mechanism, to return to the starting point by means of a descent mechanism to a return, collector (15), transporter in the bottom, return line (16), FIGS. 1, 3, 4 and 5. The sliding steps are designed with a system of embedded balls or supports (17) FIG. 5, and with an inferior border that facilitates their displacement when carrying large loads. On the four corners, the sliding steps have rollers (18) FIG. 5, that contribute to the movement through the guides. For their movement, all along the sides have metallic inserts (21) FIG. 5, which are attracted by the system of electromagnets (12) FIG. 7, for the acceleration and deceleration.

On both sides of uniformly varied speed mechanism, two rails are mounted handrail speed synchronized with their movement, built with a mechanism similar to yours at the appropriate scale to be supported with the hands. (25) FIG. 6

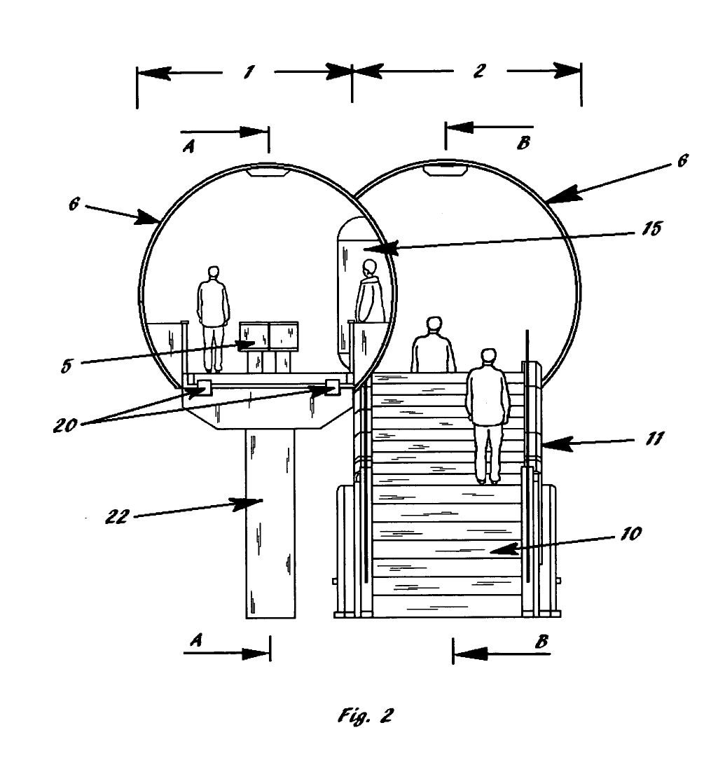

The Covered Linear Transporting Floor Mechanism, can move the floor with an electromagnetic suspension and a propulsion mechanism (20) FIGS. 1, 2 and 7.

This system can be built on a way similar to the elevated monorail or train systems when it comes to the supporting structure and the dimensions of the access points, which opens the doors to the transformation of the existing systems. The Covered Linear Transporting Floor Mechanism would lay on these structures over the defined route, inside the transparent tunnel, with only the moving floor going at constant speed. The current stations could be used to build the access locations. For the hours of low demand, the moving floor of the Covered Linear Transporting Floor Mechanism can be stopped, folding a series of seats, to allow the movement of a selected group of seats, resembling the actual transportation systems.

This invention can be built using different types of movement systems, from mechanicals to electromagnetic, based on the specific needs and budget, without altering the principle of functioning.

This invention is applicable as an alternative or complement to the urban transportation systems in the cities; for access to airports and/or sports complexes, by helping to reduce the size of the parking lots; among others. Its capacity of transport is about five times superior to a highway of four lanes.

This invention is applicable also to industrial process; loading/unloading of moving vehicles; merchandise/luggage movement in airports and ports. The Uniformly Varied Movement Mechanism can be used independently for exercising or entertainment also.

### Summary of the Invention's Benefits

The society as a whole can benefit from this invention, by decreasing the number of vehicles on the highways and as a consequence, the disturbing traffic clogs; it can help to decrease the pollution; time losses; fuel consumption; lack of parking spaces. It can contribute to improve the movement of merchandise at the airports and ports. It could be used for exercising and entertainment also.

1. A Passengers' Transportation System with Continuous Movement: It is a system designated for transporting large volumes of passengers or cargo, without stopping its movement. It is formed by two types of conveyors of continuous operation: a main transporter that connects different points in a given route and an auxiliary transporter attached to the main one, but only in some points (separated by certain distances) alongside the route and serves as entrances and exits stations.

2. A. Passengers' Transportation System with Continuous Movement According to Claim No. 1: the auxiliary transporter includes a moving sidewalk or mat, formed by independent platforms, organized in three different speed zones: the first one begins at walking speed and stars the acceleration process; a second one which moves at the same speed with the main conveyer (so the passengers can get up and down);
and the third one where the system reduces its acceleration to walking speed again. The system design is compact, simple, lightweight, and can be mounted on existing city roads, such as streets, highways, airports, ports, marinas and commercial centers, subways, elevated trains and also in industrial process lines, among others.

3. A. Passengers' Transportation System with Continuous Movement According to claim No 1: The main conveyor line moves at a uniform speed, and within a closed loop in the horizontal plane, formed by platforms that move hinged to each other, on an appropriate track (supported electromagnetically or by bearings, as desired), using electric thrusters, external or mounted on them and link stations (access points) located in convenient points of a given route, where are located the auxiliary transporters.

4. A. Passengers' Transportation System with Continuous Movement According to claim No 1: The main conveyor may or may not be covered fully or partially along its path and may have seats and other complementary elements according to the main purpose of this specific transporter: passenger transportation or freight.

5. A. Passengers' Transportation System with Continuous Movement According to claim No 1: Auxiliary conveyor varies its speed by the displacement of its floor platforms, which are mounted or disassembled one on each other, among other possible options by a set of gear sprockets coupled by a zipper like mechanism cut at the edges of the platforms surface, fixing its position by arms with retractable bearings that connect the pinions to lateral grooves on the platforms, or can also be moved in variable motion by electromagnetic suspension and displacement.

6. A. Passengers' Transportation System with Continuous Movement According to claim No. 6: Variable motion of the platforms can also be produced through a series of electromagnets that attract them through metal inserts placed at certain points of the platforms. These points receive electrical power at a variable rate depending on the position in which they are, so they can produce the necessary acceleration.

7. A. Passengers' Transportation System with Continuous Movement According to claim No. 7: Platforms that form the floor of the Auxiliary Conveyor, are supported at the base and sides to the guidelines of the structure by bearing or by Passengers' Transportation System with Continuous Movement electromagnetic suspension and power, so they can follow certain path, corresponding to their gradual changes of speed, and preventing the appearance of empty spaces between them.

8. A. A Passengers' Transportation System with Continuous Movement According to claim No. 6: The displacement of the platforms is both: positive (deployment) to accelerate at the entry and negative (withdrawal) for slowing at the exit. This way the same number of platforms increases and decreases its length, changing the speed.

9. A. Passengers' Transportation System with Continuous Movement According to claim No. 1: Not having to stop their movement at the stations along the route of the main conveyor, you can locate all needed auxiliary transporters, to facilitate the adequate flow of passengers or cargo to and from the main transporter.

10. A. Passengers' Transportation System with Continuous Movement According to claim No. 1: The main conveyor for transporting passengers can have on its moving floor some seats, that can move in isolated groups even while the rest of the system is paused. This way the system can operate as a traditional discontinuous system in the hours of low demand.

11. A. Passengers' Transportation System with Continuous Movement According to claim No. 11: The seats placed on the conveyor, can have alert intelligent systems, so people do not have to worry about being attentive to where they need to get off (and without bothering other passengers).

12. A. Passengers' Transportation System with Continuous Movement According to claim No. 1: You can only move the floor of the conveyors within tunnels of transparent material that can be fully or partially covered by panels of photocells to produce electricity, or may be discovered when assembled under other existing covered structures, such like airports corridors or other.

13. A. Passengers' Transportation System with Continuous Movement According to claim No. 7: The gear motors that move the platforms could be attached to the racks with pinions mechanisms of “free wheel” to absorb the difference in speed that occurs between them at certain moments times given for the same purpose, the gears are connected to the bike reducing elastic torsion by shafts to reduce gear shifting on the platforms, in mechanical variant

14. A. Passengers' Transportation System with Continuous Movement According to claim 13: The gear motors that move the platforms pass their transmission pinions from one platform to the next, using a retractable claw mechanism, which decouples in one of the platforms and couples in the next one during their advance, in mechanical variant.

15. A. Passengers' Transportation System with Continuous Movement According to claim No. 13: The gear motors that move the platform, in mechanical variant, change their speed when passing from one platform to another, using an acceleration system, linked to the change in angle that occurs during the upward or downward movement of the platforms in its path.

16. A. Passengers' Transportation System with Continuous Movement According to claim No. 6: The movement cycle of the platforms in its path is closed at the ends, by delivery systems that guarantee their synchronized way from one end to another, at the bottom side of the auxiliary conveyor.
